(19) United States
(12) Patent Application Publication
(10) Pub. No.: US 2019/0043496 A1
(43) Pub. Date: Feb. 7, 2019

(54) DISTRIBUTED SPEECH PROCESSING

(71) Applicant: Intel Corporation, Santa Clara, CA (US)

(72) Inventors: Doron Tal, Kfar Shmaryahu (IL); Michael Rosenzweig, San Ramon, CA (US); Guru Raj, Hillsboro, OR (US); Hannah Colett, Portland, OR (US); Tao Tao, Portland, OR (US); Ze'ev Rivlin, Raanana (IL); Scott L. Kovesdy, Chandler, AZ (US); Anitha Suryanarayan, Hillsboro, OR (US)

(21) Appl. No.: 15/933,832

(22) Filed: Mar. 23, 2018

Related U.S. Application Data
(60) Provisional application No. 62/564,417, filed on Sep. 28, 2017.

(51) Int. Cl. G10L 15/22; G10L 15/08; G10L 15/28

(52) U.S. Cl. CPC G10L 15/22; G10L 15/08; G10L 2015/088; G10L 2015/223; G10L 15/28

(57) ABSTRACT

Systems, methods, and circuitry for performing distributed speech processing are provided. In one example voice activation circuitry is configured to receive audio data detected by a gateway that is connected to a plurality of devices and recognize a key phrase based on the audio data. In response to recognizing the key phrase, the voice activation circuitry is configured to store the audio data in memory located in the gateway and provide the stored audio data to a selected device in the plurality of devices for speech processing.

### CROSS REFERENCE TO RELATED APPLICATION

This application claims the benefit of priority to U.S. Provisional Patent Application No. 62/564,417 filed on Sep. 28, 2017 which is incorporated herein in its entirety for all purposes.

### BACKGROUND

Speech based Smart Home usages are gaining traction in the market. Many personal assistant/speech recognition solutions are cloud-based with only the key phrase detection running locally on an in-home speech recognition device.

### BRIEF DESCRIPTION OF THE DRAWINGS

FIG. 1 illustrates an exemplary gateway.

FIG. 2 illustrates a local network that includes a gateway that can access cloud-based services as well as other network devices to accomplish speech processing in accordance with various aspects described.

FIG. 3 illustrates a flow diagram of an example method performed by a gateway to facilitate speech processing in accordance with various aspects described.

FIG. 4 illustrates an example voice activation circuitry for use by a gateway to access other network devices to accomplish speech processing in accordance with various aspects described.

FIG. 5 illustrates a flow diagram of an example method performed by a gateway to coordinate speech based processing in a local network in accordance with various aspects described.

FIG. 6 illustrates an example gateway that can access cloud-based services to accomplish speech processing in accordance with various aspects described.

FIG. 7A illustrates a flow diagram of an example method performed by voice activation circuitry to enable speech based processing using a cloud-based service in accordance with various aspects described.

FIG. 7B illustrates a flow diagram of an example method performed by a speech service client acting in concert with the voice activation circuitry to enable speech based processing using a cloud-based service in accordance with various aspects described.

### DESCRIPTION

Some speech services are tied to the cloud-based operating system OSV. In these cases, standalone, installable speech applications are not available for platforms that do not/cannot host the relevant operating system (OS). Other speech services are paid services which are generally licensed by certain original equipment manufacturers (OEMs) for their target platform.

With cloud-based models, there is significant added network load, especially if there are frequent interactions with a speech based assistant. This load increases linearly with multiple concurrent speakers. For evolving usages like smart home surveillance, elder care, child safety, and so on, continuous audio analysis is desired. Cloud-based analytical capabilities would have a significant impact on network load thereby compromising other use cases like video streaming and gaming.

Continuous, real time speech recognition and audio analytics are compute, power, and memory intensive. For these reasons, most existing speech assistant solutions are limited to devices such as desktops, personal computers, and phones, which have higher compute capabilities and larger memory platforms. Due to their limited computing power, other classes of devices such as gateways and network access servers (NAS) are not targeted for speech based usage because delivering a compelling speech based user experience on low cost platforms with limited compute and memory capacity such as gateways or NAS is challenging. This is due to the need to allocate resources for continuous speech signal processing which severely limits the capabilities of the device and could adversely affect performance of primary usages such as packet processing or multimedia storage and retrieval.

Gateways are commonly connected with multiple computing entities (edge devices) and media peripherals and thus can facilitate a distributed architecture. A key benefit of distributed architecture in a home or personal cloud setting is the ability to distribute workloads using resources within the personal cloud before invoking external services. This leads to lowering load on the network and thus reduces total cost of services by enabling lower cost end-points. Further, many gateways now include more powerful processors that are capable of providing at least some speech processing.

Described herein are systems, methods, and circuitries that enable speech and voice based personal assistant and smart home usages on limited compute and memory headroom platforms such as gateways and NAS by taking advantage of the distributed architecture of existing compute infrastructure in most homes. The gateway and NAS are equipped to utilize emerging and mature speech technologies such as voice activation (i.e., low power “always listening” key phrase detection and voice recognition) that scales to any cloud-based speech engine. The capability of a low compute device such as a gateway or NAS to selectively offload speech/audio processing to other devices in the home network or to cloud-based services is leveraged to save power, boost efficiency, and support multiple smart home usages. This hybrid host-network device-cloud model accommodates multiple media capabilities such as personal assistance, smart home/ease of living, analytics for home surveillance even on limited compute gateway or NAS platforms.

To optimize overall platform performance, speech recognition is typically preceded by voice activation. In one example, this voice activation capability may be offloaded to a dedicated audio digital signal processor (DSP) in the gateway or NAS. In this manner, a gateway or NAS may perform preliminary signal processing operations and then package and transport the data to another device on the network or a cloud-based service that is better equipped to handle the audio data.

The present disclosure will now be described with reference to the attached figures, wherein like reference numerals are used to refer to like elements throughout, and wherein the illustrated structures and devices are not necessarily drawn to scale. As utilized herein, terms “module”, “component,” “system,” “circuit,” “element,” “slice,” “circuitry,” and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term “set” can be interpreted as “one or more.”

As another example, circuitry or similar term can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include one or more processors therein to execute executable instructions stored in computer readable medium and/or firmware that confer(s), at least in part, the functionality of the electronic components.

It will be understood that when an element is referred to as being “electrically connected” or “electrically coupled” to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being electrically coupled or connected to one another. Further, when electrically coupled or connected to one another, one element may be capable of inducing a voltage or current flow or propagation of an electro-magnetic wave in the other element without physical contact or intervening components. Further, when a voltage, current, or signal is referred to as being “applied” to an element, the voltage, current, or signal may be conducted to the element by way of a physical connection or by way of capacitive, electro-magnetic, or inductive coupling that does not involve a physical connection.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

In the following description, a plurality of details is set forth to provide a more thorough explanation of the embodiments of the present disclosure. However, it will be apparent to one skilled in the art that embodiments of the present disclosure may be practiced without these specific details. In other instances, well-known structures and devices are shown in block diagram form rather than in detail in order to avoid obscuring embodiments of the present disclosure. In addition, features of the different embodiments described hereinafter may be combined with each other, unless specifically noted otherwise.

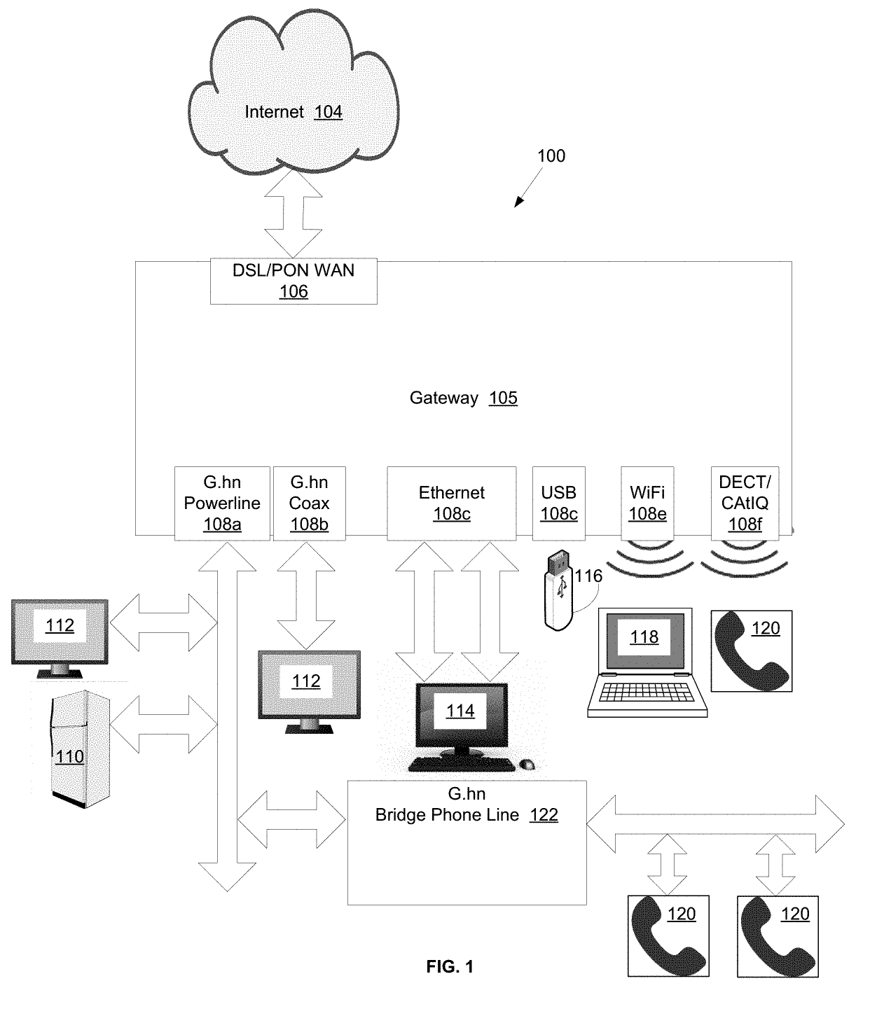

FIG. 1 illustrates an example home gateway system 100 with data connections of multiple different standards. In particular, gateway 105 is shown connected to the Internet 104 via an interface including a DSL (digital subscriber line), PON (passive optical network), or through a WAN (wide-area network). Likewise, the gateway is connected via a diverse set of standards 108 a-f to multiple devices in the “home”. For example, gateway 105 may communicate according to the International Telecommunication Union's ‘G.hn’ home network standard, for example over a power line 108a to appliances such as refrigerator 110 or television 112. Likewise, G.hn connections may be established by coaxial cable 108b to television 112.

Communication with gateway 105 over Ethernet 108c, universal serial bus (USB) 108d, WiFi (wireless LAN) 108e, or digital enhanced cordless telephone (DECT) 108f can also be established, such as with computer 114, USB device 116, wireless-enabled laptop 118 or wireless telephone handset 120, respectively. Alternatively, or in addition, bridge 122, connected for example to gateway 102 via G.hn powerline connection 108a may provide G.hn telephone access interfacing for additional telephone handsets 120. It should be noted however, that the present disclosure is not limited to home gateways, but is applicable to any network access servers (NAS) or router designed for use in connecting several computing devices to the Internet.

Home gateways such as gateway 105 may serve to mediate and translate the data traffic between the different formats of standard interfaces, including exemplary interfaces 108. Modern data communication devices like gateway 105 and also so-called edge devices (i.e., devices that utilize the gateway 105 to communicate with the Internet) often contain multiple processors and hardware accelerators which are integrated in a so-called system on chip (SOC) together with other functional building blocks. The processing and translation of the above mentioned communication streams require the high computational performance and bandwidth of the SOC architecture. To this end, the devices often include a hardware accelerator, which is a hardware element designed to perform a narrowly defined task. The hardware accelerator may exhibit a small level of programmability but is in general not sufficiently flexible to be adapted to other tasks. For the predefined task, the hardware accelerator shows a high performance with low power consumption resulting in a low energy per task figure.

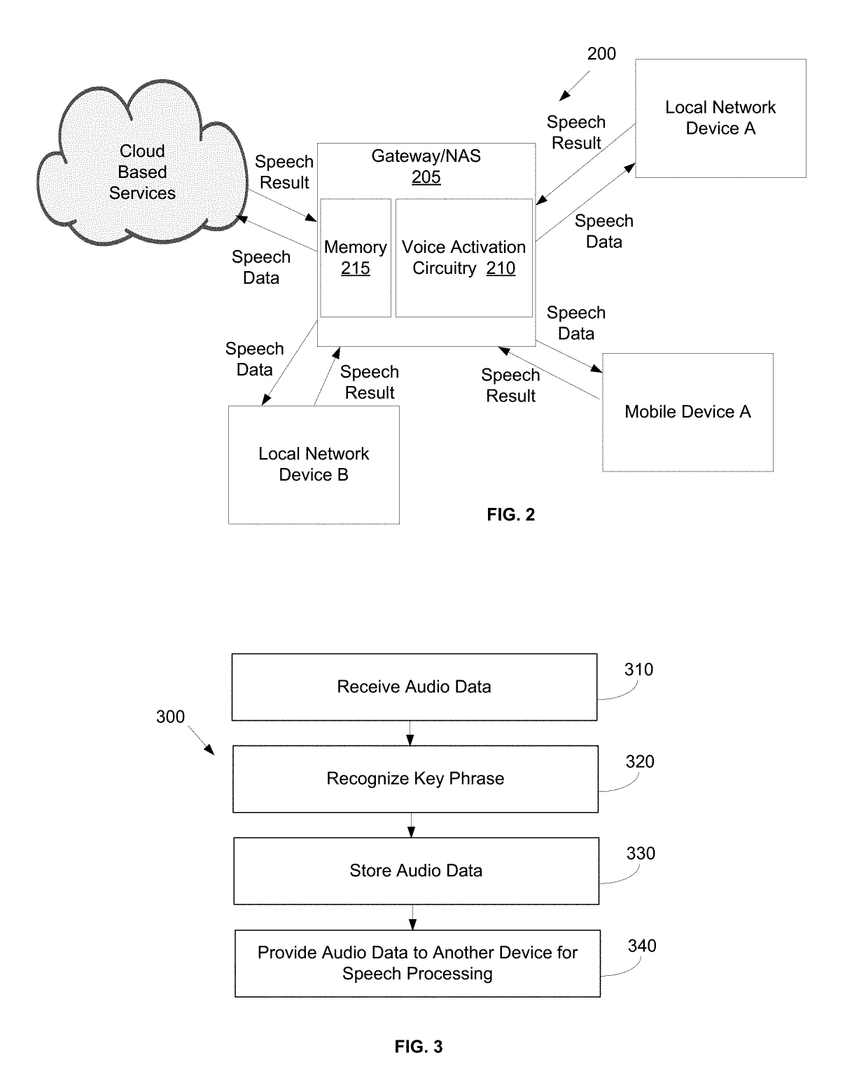

FIG. 2 illustrates an example gateway network 200 that includes a gateway/NAS 205 that is connected, by way of a local network to three devices and, by way of an Internet connection (e.g., DSL or broadband), to one or more cloud-based services. To facilitate speech processing, the gateway/NAS 205 includes voice activation circuitry 210 and memory (e.g., buffer) 215. The voice activation circuitry 210 is configured to receive audio data collected or detected by the gateway/NAS 205. The voice activation circuitry 210 is configured to recognize one or more key phrases, and in response, and store the audio data in the memory 215 and transmit or otherwise provide (e.g., offload) the stored audio data to a selected device in the network (including devices that embody the cloud based services) for speech processing. In one example the voice activation circuitry 210 is a low power hardware based digital signal processor (DSP). In one example, the voice activation circuitry is configured to receive a speech result from the device and provide the result to a user of the gateway/NAS 205. In this manner, the gateway/NAS 205 is able to provide low compute functions such as voice activation and speech processing and any further compute intensive processing can be offloaded to another device in the network.

FIG. 3 illustrates a flow diagram of an example method 300 that may be performed by voice activation circuitry 210. The method includes, at 310, receiving audio data from the gateway. The audio data may be received from a microphone or other device that is part of the gateway. At 320, the method includes recognizing a key phrase. At 330, the audio data is stored in memory in the gateway. At 340, the audio data is provided to another device for speech processing. The audio data may be provided by transmitting the audio data by way of a network connection, packaging the audio data so that the audio data is compatible with a processor in the other device and transmitting the packet or package, and/or storing the audio data or audio data packet in memory that is accessible to the other device.

FIG. 4 illustrates an example voice activation circuitry 410 that is part of a gateway/NAS (not shown) that supports a local network with three devices. While the gateway/NAS may have limited audio/speech processing functions due to resource constraints, the other devices in the local network may have specialized hardware such as accelerators, more powerful processors, and/or more resource availability for speech processing. To leverage the speech processing capabilities of the other devices, the voice activation circuitry 410 is configured to offload speech processing tasks to the other devices according to a media offload management policy (MOMP) 435 that is based on the devices' individual capabilities.

The gateway's voice activation circuitry 410 serves as the principal audio data processing node within the local network. The voice activation circuitry 410 includes audio processing circuitry 420 configured to receive audio data from the gateway (e.g., from a microphone or other detection device that provides audio data to the gateway) and, in response to recognizing a key phrase, store the audio data in gateway memory (e.g., 215 in FIG. 2).

The voice activation circuitry includes distribution circuitry 440 configured to select another device to perform speech processing that is beyond the capability of the gateway and transmit the stored audio data to the selected device. The distribution circuitry 440 is configured to identify one or more types of speech processing that are associated with a recognized key phrase. For example, the key phrase “Alexa” may be interpreted as an indication that natural language understanding and dialog management speech processing should be performed. If the gateway is not capable of performing the required speech processing, the distribution circuitry 440 will offload the audio data to another device. In this manner, audio/speech use cases that cannot be processed and handled locally on the client/edge are pushed onto the local distributed compute network. Since all network traffic is routed through the gateway, this audio data may undergo additional processing at the gateway. The distribution circuitry 440 is configured to select a device to offload audio/speech processing based on the MOMP 435, which may be stored in gateway memory. The gateway handles MOMP 435 implementation and enforcement.

Classification circuitry 430 leverages the fact that the gateway has complete visibility of devices within the home network. To generate the MOMP 435, the classification circuitry 430 enumerates and classifies categories of devices within the network based on types of speech processing capabilities such as compute capabilities and available specialized hardware for media processing as well as transport protocols that are supported (i.e., for transmitting and receiving audio data). The discovery of network device capabilities can be designed in many ways, including the following example methods.

A new class of device called “analytic_device” can be introduced into the Open Connectivity Foundation. This new class can describe the overall computing capability of the device such as available hardware accelerators and associated properties such as supported media stream formats (e.g., bit depth, sampling rate, channels and CODEC) and also the capability to support multiple concurrent workloads. A derived class called “analytic_device_resource” may also be introduced that includes current resource availability of the analytic_device.

Each device that enters the network advertises information contained in the analytic_device class to the gateway during the discovery phase. The gateway uses this information to maintain and implement the MOMP 435. The analytic_device periodically transmits information contained in the analytic_device_resource class. This transmission can be a user datagram protocol (UDP) based unicast packet targeted for the gateway device with the payload containing resource availability information. The resource information may be represented in a simple JavaScript Object Notation (JSON) format.

In one example, if the device is awake, powered on, and has resources available to handle specific voice and speech workloads, the device transmits its resource availability information intermittently. In this case, packet loss may be tolerated and hence retries may not be necessary. In another example, if the device's resource availability has significantly changed (e.g., an increase or decrease of at least 20%) then the device transmits its resource availability once with up to 3 retries to account for packet losses. In a final example, the gateway multicasts to the devices in the network thereby querying each device for resource availability.

In addition to cataloguing static network device processing capabilities, such as accelerators and transport protocol support, the classification circuitry 430 also records dynamic parameters, such as a link speed and available resources (battery charge level, memory availability, processor load, and so on) for each network device. The link speed and available resources may change fairly often and the classification circuitry 430 may employ any of the above methods to monitor the dynamic parameters on an ongoing basis and update the MOMP 435 accordingly.

For example, in FIG. 4 it can be seen Desktop-001 has a Core-19 compute class and also has a neural net accelerator, an audio DSP, and a graphics processing unit (GPU). The classification circuitry 430 may record this information in the MOMP 435 and based on this information the classification circuitry 430 assigns several types of speech processing capabilities to Desktop-001 including natural language understanding, dialog management, speech recognition, and acoustic event classification. For each capability type, a priority is assigned to the device. Thus, according to the MOMP 435 Computer-001 is the first device that will be chosen to perform speech processing that requires natural language understanding or dialog management. If Computer-001 is not available (e.g., offline, has been temporarily moved out of range of the network, and so on), or has a low link speed or compute resource availability (e.g., below a threshold) then NUC-001 will be next considered for offloading the speech processing that requires natural language understanding or dialog management.

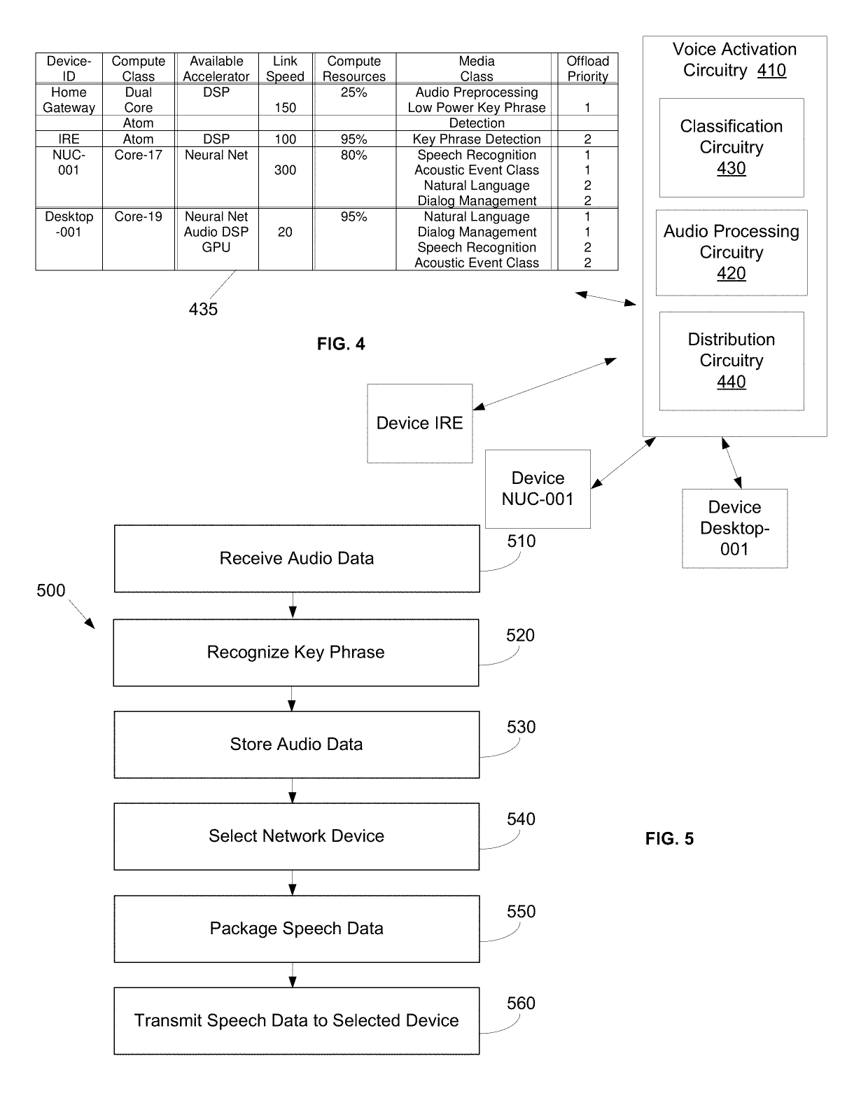

FIG. 5 illustrates a flow diagram of an example method 500 that may be performed by the voice activation circuitry 410. At 510, the method includes receiving audio data detected by a gateway. At 520, the method includes recognizing a key phrase. At 530, the method includes storing the audio data in memory located in the gateway. At 540, the method includes selecting the device to which to transmit the audio data based on a media offload management policy. At 550, the method includes packaging the audio data based on the selected device. At 560, the method includes transmitting the packaged audio data to the selected device by way of a network connection.

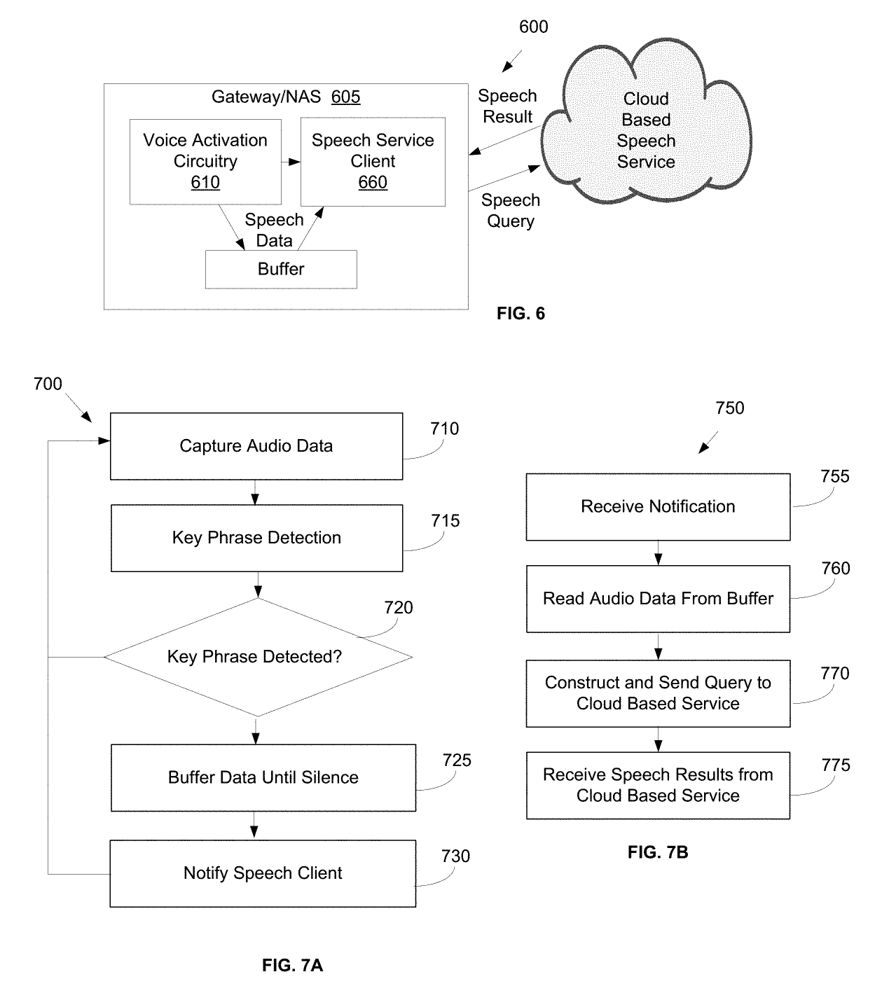

FIG. 6 illustrates a network 600 that includes a gateway/NAS 605 connected, by way of the Internet (e.g., DSL, broadband, fiber optic, and so on), to a cloud-based speech service. The gateway/NAS 605 includes voice activation circuitry 610, a speech service client 660, and a buffer (e.g., memory 215 of FIG. 2). The voice activation circuitry 610, which may be a low power hardware based DSP, always listens for one or more key phrases. Once the key phrase is detected, the voice activation circuitry 620 stores audio data in the buffer. The speech service client 660 captures the audio buffer and sends a speech query containing the contents to the cloud-based speech service. The speech service recognizes the audio data and sends a speech result back to the speech service client 660.

FIG. 7A illustrates a flow diagram of a method 700 that may be performed by the voice activation circuitry 610. At 710, the method includes capturing audio data. At 715, the method includes determining if a key phrase is detected. At 720, if the key phrase is detected, at 725 the audio data following the key phrase is buffered (e.g., stored in the buffer) until silence is detected. At 730, a speech client is notified that the buffer contains audio data for a query.

FIG. 7B illustrates a flow diagram of a method 750 that may be performed by the speech service client 660. At 755, the method includes receiving a notification from voice activation circuitry. At 760, the method includes reading audio data in the buffer. At 770, the method includes constructing and sending a speech query to a cloud-based speech service. At 775, speech results are received from the cloud-based speech service.

Based on workloads and available compute/memory resources, a gateway could also be tasked with handling several combinations of audio/speech operations including but not limited to local speech recognition, intent extraction, speaker identification, gender detection, emotion detection, event classification, ethnicity estimation, age estimation, music genre classification etc. For example, with a low power based wake feature provided by the gateway enabled, a cloud-based speech engine can be engaged to serve spoken commands for a personal assistant or smart home application. In this scenario, the gateway or NAS is only required to buffer the speech command, package and transport it to the cloud-based engine for further processing and analysis.

Optional optimizations can include hardware offloaded, low power voice based wake triggers, hardware acceleration for neural network based acoustic event classification, natural language processing, speaker identification etc. These capabilities may be enabled through the gateway itself or via any edge devices that are part of the distributed architecture.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

Examples can include subject matter such as a method, means for performing acts or blocks of the method, at least one machine-readable medium including instructions that, when performed by a machine cause the machine to perform acts of the method or of an apparatus or system for distributed speech processing using a gateway according to embodiments and examples described herein.

Example 1 is voice activation circuitry, configured to receive audio data detected by a gateway, wherein the gateway is connected to a plurality of devices and recognize a key phrase based on the audio data. In response to recognizing the key phrase, the voice activation circuitry is configured to store the audio data in memory located in the gateway and provide the stored audio data to a selected device in the plurality of devices for speech processing.

Example 2 includes the subject matter of example 1, including or omitting optional elements, wherein the voice activation circuitry includes distribution circuitry configured to: select the device to which to transmit the audio data based on a media offload management policy; package the audio data based on the selected device; and transmit the packaged audio data to the selected device by way of a network connection.

Example 3 includes the subject matter of example 2, including or omitting optional elements, further including classification circuitry configured to: determine one or more types of speech processing capabilities for the plurality of devices; assign, for each type of speech processing, a prioritized sequence of devices having capability for the type of speech processing; and store the prioritized sequences of devices for each type of speech processing as the media offload management policy.

Example 4 includes the subject matter of example 3, including or omitting optional elements, wherein the classification circuitry configured to: receive communications from the plurality of devices that include speech capabilities for corresponding devices; and assign the prioritized sequence of devices based on the communications.

Example 5 includes the subject matter of example 3, including or omitting optional elements, wherein one type of speech processing capability includes a processor class for the device.

Example 6 includes the subject matter of example 3, including or omitting optional elements, wherein one type of speech processing capability includes a hardware accelerator present in the device.

Example 7 includes the subject matter of example 3, including or omitting optional elements, wherein one type of speech processing capability includes a link speed between the gateway and the device.

Example 8 includes the subject matter of example 3, including or omitting optional elements, wherein one type of speech processing capability includes available compute resources of the device.

Example 9 includes the subject matter of example 1, including or omitting optional elements, wherein: the gateway includes a speech service client; and the voice activation circuitry is configured to store the audio data in a buffer that is read by the speech service client to construct a speech query for a cloud based speech service; and notify the speech service client when audio data is stored in the buffer.

Example 10 includes the subject matter of example 1, including or omitting optional elements, including a low-power hardware-based digital signal processor (DSP).

Example 11 is a method including: receiving audio data detected by a gateway, wherein the gateway is connected to a plurality of devices; recognizing a key phrase based on the audio data; and in response to recognizing the key phrase, storing the audio data in memory located in the gateway; and providing the stored audio data to a selected device in the plurality of devices for speech processing.

Example 12 includes the subject matter of example 11, including or omitting optional elements, further including: selecting the device to which to transmit the audio data based on a media offload management policy; packaging the audio data based on the selected device; and transmitting the packaged audio data to the selected device by way of a network connection.

Example 13 includes the subject matter of example 12, including or omitting optional elements, further including: determining one or more types of speech processing capabilities for the plurality of devices; assigning, for each type of speech processing, a prioritized sequence of devices having capability for the type of speech processing; and storing the prioritized sequences of devices for each type of speech processing as the media offload management policy.

Example 14 includes the subject matter of example 13, including or omitting optional elements, further including: receiving communications from the plurality of devices that include speech capabilities for corresponding devices; and assigning the prioritized sequence of devices based on the communications.

Example 15 includes the subject matter of example 11, including or omitting optional elements, wherein the gateway includes a speech service client, and wherein the method further includes: storing the audio data in a buffer that is read by the speech service client to construct a speech query for a cloud based speech service; and notifying the speech service client when audio data is stored in the buffer.

Example 16 is a method configured to generate a media offload management policy, including: determining one or more types of speech processing capabilities for a plurality of devices in a network that includes a gateway; assigning, for each type of speech processing, a prioritized sequence of devices having capability for the type of speech processing; and storing, in a gateway memory, the prioritized sequences of devices for each type of speech processing as the media offload management policy.

Example 17 includes the subject matter of example 16, including or omitting optional elements, further including: receiving communications from the plurality of devices that include speech capabilities for corresponding devices; and assigning the prioritized sequence of devices based on the communications.

Example 18 includes the subject matter of example 16, including or omitting optional elements, wherein one type of speech processing capability includes a processor class for the device.

Example 19 includes the subject matter of example 16, including or omitting optional elements, wherein one type of speech processing capability includes a hardware accelerator present in the device.

Example 20 includes the subject matter of example 16, including or omitting optional elements, wherein one type of speech processing capability includes a link speed between the gateway and the device.

Example 21 includes the subject matter of example 16, including or omitting optional elements, wherein one type of speech processing capability includes available compute resources of the device.

Various illustrative logics, logical blocks, modules, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine. The various illustrative logics, logical blocks, modules, and circuits described in connection with aspects disclosed herein can be implemented or performed with a general purpose processor executing instructions stored in computer readable medium.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature may have been disclosed with respect to only one of several implementations, such feature may be combined with one or more other features of the other implementations as may be desired and advantageous for any given or particular application. The use of the phrase “one or more of A, B, or C” is intended to include all combinations of A, B, and C, for example A, A and B, A and B and C, B, and so on.

What is claimed is:

1. Voice activation circuitry, configured to:
receive audio data detected by a gateway, wherein the gateway is connected to a plurality of devices;
recognize a key phrase based on the audio data; and
in response to recognizing the key phrase,
store the audio data in memory located in the gateway; and
provide the stored audio data to a selected device in the plurality of devices for speech processing.

2. The voice activation circuitry of claim 1, wherein the voice activation circuitry comprises distribution circuitry configured to:
select the device to which to transmit the audio data based on a media offload management policy;
package the audio data based on the selected device; and
transmit the packaged audio data to the selected device by way of a network connection.

3. The voice activation circuitry of claim 2, further comprising classification circuitry configured to:
determine one or more types of speech processing capabilities for the plurality of devices;
assign, for each type of speech processing, a prioritized sequence of devices having capability for the type of speech processing; and
store the prioritized sequences of devices for each type of speech processing as the media offload management policy.

4. The voice activation circuitry of claim 3, wherein the classification circuitry configured to:
receive communications from the plurality of devices that include speech capabilities for corresponding devices; and
assign the prioritized sequence of devices based on the communications.

5. The voice activation circuitry of claim 3, wherein one type of speech processing capability comprises a processor class for the device.

6. The voice activation circuitry of claim 3, wherein one type of speech processing capability comprises a hardware accelerator present in the device.

7. The voice activation circuitry of claim 3, wherein one type of speech processing capability comprises a link speed between the gateway and the device.

8. The voice activation circuitry of claim 3, wherein one type of speech processing capability comprises available compute resources of the device.

9. The voice activation circuitry of claim 1, wherein:
the gateway includes a speech service client; and
the voice activation circuitry is configured to store the audio data in a buffer that is read by the speech service client to construct a speech query for a cloud based speech service; and
notify the speech service client when audio data is stored in the buffer.

10. The voice activation circuitry of claim 1, comprising a low-power hardware-based digital signal processor (DSP).

11. A method, comprising:
receiving audio data detected by a gateway, wherein the gateway is connected to a plurality of devices;
recognizing a key phrase based on the audio data; and
in response to recognizing the key phrase,
storing the audio data in memory located in the gateway; and
providing the stored audio data to a selected device in the plurality of devices for speech processing.

12. The method of claim 11, further comprising:
selecting the device to which to transmit the audio data based on a media offload management policy;
packaging the audio data based on the selected device; and
transmitting the packaged audio data to the selected device by way of a network connection.

13. The method of claim 12, further comprising:
determining one or more types of speech processing capabilities for the plurality of devices;
assigning, for each type of speech processing, a prioritized sequence of devices having capability for the type of speech processing; and
storing the prioritized sequences of devices for each type of speech processing as the media offload management policy.

14. The method of claim 13, further comprising:
receiving communications from the plurality of devices that include speech capabilities for corresponding devices; and
assigning the prioritized sequence of devices based on the communications.

15. The method of claim 11, wherein the gateway includes a speech service client, and wherein the method further comprises:
storing the audio data in a buffer that is read by the speech service client to construct a speech query for a cloud based speech service; and
notifying the speech service client when audio data is stored in the buffer.

16. A method configured to generate a media offload management policy, comprising:
determining one or more types of speech processing capabilities for a plurality of devices in a network that includes a gateway;
assigning, for each type of speech processing, a prioritized sequence of devices having capability for the type of speech processing; and
storing, in a gateway memory, the prioritized sequences of devices for each type of speech processing as the media offload management policy.

17. The method of claim 16, further comprising:
receiving communications from the plurality of devices that include speech capabilities for corresponding devices; and
assigning the prioritized sequence of devices based on the communications.

18. The method of claim 16, wherein one type of speech processing capability comprises a processor class for the device.

19. The method of claim 16, wherein one type of speech processing capability comprises a hardware accelerator present in the device.

20. The method of claim 16, wherein one type of speech processing capability comprises a link speed between the gateway and the device.

21. The method of claim 16, wherein one type of speech processing capability comprises available compute resources of the device.
